(19) United States
(12) Patent Application Publication
(10) Pub. No.: US 2002/0143109 A1
(43) Pub. Date: Oct. 3, 2002

(54) Process for preparing stable gel-type cation exchangers

(76) Inventors: Wolfgang Podszun, Koln (DE); Glandia Schmid, Leichlingeng (DE); Rudiger Seidel, Leverkusen (DE); Reinhold Klipper, Koln (DE)

Correspondence Address: BAYER CORPORATION, PATENT DEPARTMENT, 100 BAYER ROAD, PITTSBURGH, PA, 15205, US

(21) Appl. No.: 09/974,417

(22) Filed: Oct. 9, 2001

(30) Foreign Application Priority Data
Oct. 13, 2000 (DE) 10050680.1

(51) Int. Cl. C08F 120/44

(52) U.S. Cl. 525/329.1; 525/333.9; 525/333.3; 521/26

(57) ABSTRACT

The invention relates to a process for preparing stable gel-type cation exchangers by sulfonating acrylonitrile-containing bead polymers, to the gel-type cation exchangers themselves, and to their uses.

### BACKGROUND OF THE INVENTION

The invention relates to a process for preparing stable gel-type cation exchangers by sulfonating acrylonitrile-containing bead polymers, to the gel-type cation exchangers themselves, and also to their uses.

Cation exchangers are well-known products described in detail, for example, in “Ion Exchange”, Kirk-Othmer Encyc. Chem. Tech. Volume 14, pages 737-783 (fourth edition 1995).

Strongly acidic cationic exchangers are generally obtained by sulfonating a divinylbenzene-crosslinked styrene bead polymer. Sulfonation using concentrated sulfuric acid is particularly cost-effective here. However, a disadvantage is that the use of sulfuric acid as sulfonating agent often requires the use of a swelling agent, such as dichloroethane, if relatively highly crosslinked styrene bead polymers are to be sulfonated completely and uniformly.

DE-B 1,227,431 discloses the sulfonation of acrylonitrile-containing copolymers, using sulfuric acid.

EP-A 994,124 describes a process for preparing microencapsulated bead-type polymers made from hydrophobic and hydrophilic monomer, where the hydrophilic monomer may be acrylonitrile. According to EP-A 994,124 it is also possible to produce polymers which can be sulfonated using sulfuric acid. However, the sulfonation of the cation exchangers obtained by the process of EP-A 994,124 is incomplete, and their mechanical and osmotic stability is unsatisfactory.

According to EP-A 1,000,659, a seed-feed process can be used to obtain acrylonitrile-containing polymers that are reacted by way of sulfonation to give stable and homogeneous cation exchangers. However, the preparation process is complicated, since it includes two separate polymerization steps.

Inadequate mechanical or osmotic stability of the cation exchangers leads to problems in their use. For example, cation exchanger beads can fracture during dilution after sulfonation, the cause being the osmotic forces arising. A requirement common to all applications of cation exchangers is that exchangers in bead form must retain all of their characteristics and must not undergo degradation, partial or complete, during use, or fragment. During the purification process, fragments and bead polymer shards can pass into the solutions to be purified, and themselves contaminate the solutions. The presence of damaged bead polymers is moreover undesirable for the functioning of the cation exchangers themselves when they are used in column processes. Shards lead to increased pressure loss in the column system and thus reduce the throughput of liquid to be purified through the column.

Another problem with known cation exchangers is that these tend toward undesirable leaching, caused by soluble polymers that are initially present or formed during usage.

The object of the present invention is to provide a cation exchanger with high stability and purity, particularly with high mechanical stability, and also with osmotic stability. For the purposes of the present invention, purity is primarily the capacity of the cation exchanger to avoid leaching. Leaching is evident in a rise in the conductivity of water treated with the ion exchanger.

### SUMMARY OF THE INVENTION

The subject-matter of the present invention, and thus the manner of achieving the object, is a process for preparing stable gel-type cation exchangers comprising

(1) polymerizing a mixture comprising from 90 to 95% by weight of styrene and 5 to 10% by weight of divinylbenzene by the suspension polymerization procedure at a liquor ratio (o/w) of from 1:1 to 1:2.5 in the presence of 5 to 8% by weight of acrylonitrile, based on the entirety of styrene and divinylbenzene, in the aqueous phase, and

(2) sulfonating the resultant copolymer using sulfuric acid in the absence of any swelling agent.

The subject-matter of the invention also includes the stable gel-type cation exchangers obtainable by

(1) polymerizing, in the aqueous phase, a mixture comprising from 90 to 95% by weight of styrene and 5 to 10% by weight of divinylbenzene by the suspension polymerization procedure at a liquor ratio (o/w) of from 1:1 to 1:2.5 in the presence of 5 to 8% by weight of acrylonitrile, based on the entirety of styrene and divinylbenzene, and

(2) sulfonating the resultant copolymer using sulfuric acid in the absence of any swelling agent.

### DETAILED DESCRIPTION OF THE INVENTION

For the purposes of the present invention, the term suspension polymerization means that the monomer mixture made from styrene and divinylbenzene is present in the form of droplets dispersed in an aqueous phase and is cured with the aid of a free-radical generator dissolved in the monomer mixture, by increasing the temperature.

The amount of acrylonitrile added to the aqueous phase is 5 to 8% by weight, based on the entirety of styrene and divinylbenzene. The ideal amount of acrylonitrile depends on the amount of divinylbenzene. It is preferable to set a ratio by weight of acrylonitrile to divinylbenzene of 0.6 to 1. The acrylonitrile added is incorporated into the polymer formed with incorporation rates of from 90 to 100%.

It has been found that the ratio by weight of monomer mixture to aqueous phase (liquor ratio o/w of the organic phase to the aqueous phase) is of great importance not only for the incorporation rate but also with respect to the stability of the cation exchanger. This surprising finding could be attributable to the fact that the liquor ratio is a significant control variable for the kinetics of the incorporation process and generates the spatial distribution of the acrylonitrile entering the styrene-divinylbenzene network as it develops. According to the invention, the ratio by weight of monomer mixture (styrene and divinylbenzene) to aqueous phase is 1:1 to 1:2.5, preferably 1:1.2 to 1:2.2.

In a particular embodiment of the present invention, the mixture made from styrene and divinylbenzene is used in the form of microencapsulated monomer droplets.

Materials that may be used for the microencapsulation of the monomer droplets are those known for this purpose, particularly polyesters, naturally occurring or synthetic polyamides, polyurethanes, or polyureas. A particularly suitable naturally occurring polyamide is gelatin, utilized particularly as coacervate or complex coacervate. For the purposes of the present invention, the gelatin-containing complex coacervates are especially combinations of gelatin with synthetic polyelectrolytes. Suitable synthetic polyelectrolytes are copolymers incorporating units of, for example, maleic acid, acrylic acid, methacrylic acid, acrylamide, or methacrylamide. Gelatin-containing capsules may be hardened by conventional hardeners, such as formaldehyde or glutaric dialdehyde. The encapsulation of monomer droplets, for example, by gelatin, by gelatin-containing coacervates or by gelatin-containing complex coacervates, is described in detail in EP 46,535 B1. The methods for encapsulation by synthetic polymers are known. An example of a highly suitable method is interfacial condensation, in which a reactive component dissolved in the monomer droplet (for example, an isocyanate or an acid chloride) is reacted with a second reactive component dissolved in the aqueous phase (for example, an amine). Microencapsulation by gelatin-containing complex coacervate is preferred.

The median particle size of the monomer droplets, microencapsulated or otherwise, is from 10 to 1000 μm, preferably 50 to 1000 μm, particularly preferably 100 to 750 μm. Conventional methods, such as screen analysis or image analysis, are suitable for determining the median particle size and the particle size distribution. A measure used for the breadth of the particle size distribution is the ratio formed from the 90% value (Ø(90)) and the 10% value (Ø(10)) from the volume distribution. The 90% value (Ø(90)) gives that diameter which is greater than the diameter of 90% of the particles. Correspondingly, the diameter of the 10% value (Ø(10)) exceeds that of 10% of the particles. Particle size distributions of Ø(90)/Ø(10)≦1.5, particularly Ø(90)/Ø(10)≦1.25, are preferred.

The divinylbenzene used may be of commercially available quality, which comprises ethylvinylbenzene along with the isomers of divinylbenzene, for example, as a mixture with a proportion of 80% by weight of divinylbenzene. The amount of pure divinylbenzene is 4 to 12% by weight, preferably 6 to 10% by weight, based on the entirety of styrene and divinylbenzene.

Free-radical generators that may be used for the suspension polymerization of the invention are peroxy compounds, such as dibenzoyl peroxide, dilauroyl peroxide, bis(p-chlorobenzoyl) peroxide, dicyclohexyl-peroxy dicarbonate, tert-butylperoxy benzoate, tert-butyl peroctoate, 2,5-bis(2-ethylhexanoylperoxy)-2,5-dimethylhexane, or tert-amylperoxy-2-ethylhexane, or else azo compounds, such as 2,2′-azobis(isobutyronitrile) or 2,2′-azobis(2-methylisobutyronitrile). Other highly suitable compounds are aliphatic peroxy esters, such as tert-butylperoxy isobutyrate, tert-butylperoxy 2-ethylhexanoate, or 2,5-bis(2-ethylhexanoylperoxy)-2,5-dimethylhexane. Dibenzoyl peroxide is preferred.

The amounts used of the free-radical generators to be used in the process of the invention are generally from 0.01 to 2.5 (preferably from 0.1 to 1.5% by weight), based on the mixtures made from styrene and divinylbenzene. It is, of course, also possible to use mixtures of the above-mentioned free-radical generators, for example, mixtures of free-radical generators with different decomposition temperatures.

Dispersing agents may be used to stabilize the microencapsulated monomer droplets in the aqueous phase. For the purposes of the present invention, suitable dispersing agents are naturally occurring or synthetic water-soluble polymers, such as gelatin, starch, polyvinyl alcohol, polyvinylpyrrolidone, polyacrylic acid, polymethacrylic acid, or copolymers made from (meth)acrylic acid and from (meth)acrylic esters. Other highly suitable materials are cellulose derivatives, particularly cellulose esters or cellulose ethers, such as carboxymethylcellulose or hydroxyethylcellulose. The amount of the dispersing agents used is generally from 0.05 to 1%, based on the aqueous phase, preferably from 0.1 to 0.5%.

The polymerization may be carried out in the presence of a buffer system. Preference is given to buffer systems that set the pH of the aqueous phase to a value between 12 and 3 (preferably between 10 and 4) at the start of the polymerization. Particularly highly suitable buffer systems comprise phosphate salts, acetate salts, citrate salts, or borate salts.

It can be advantageous to use an inhibitor dissolved in the aqueous phase. Either inorganic or organic substances may be used as inhibitors. Examples of inorganic inhibitors are nitrogen compounds, such as hydroxylamine, hydrazine, sodium nitrite or potassium nitrite. Examples of organic inhibitors are phenolic compounds, such as hydroquinone, the monomethyl ether of hydroquinone, resorcinol, pyrocatechol, tert-butylpyrocatechol, or condensation products made from phenols with aldehydes. Examples of other organic inhibitors are nitrogen-containing compounds, such as diethylhydroxylamine or isopropylhydroxylamine. According to the invention, resorcinol is preferred as inhibitor. The concentration of the inhibitor is 5 to 1000 ppm (preferably 10 to 500 ppm, particularly preferably 20 to 250 ppm), based on the aqueous phase.

The polymerization (hardening) of the monomer droplets, microencapsulated or otherwise, takes place at an elevated temperature, for example 50 to 150° C., preferably 60 to 140° C. The ideal polymerization temperature for a particular case can be calculated by the person skilled in the art from the half-life times of the free-radical generators. It is also possible to raise the temperature continuously during the polymerization period within the stated temperature range.

The reaction mixture is stirred during the polymerization. If the monomer mixture has not been microencapsulated, the particle size of the polymer beads which are developing may be adjusted in a manner known per se by way of the stirrer speed. When microencapsulated monomer droplets are used, the median particle size and particle size distribution have already been prescribed. In this case the stirrer speed is not significant. Use may be made of low stirrer speeds just adequate to keep the suspended particles in suspension.

After the polymerization, the polymer that is formed may be isolated using the usual methods, for example, by filtration or decanting, and, where appropriate, may be dried after one or more washes and, if desired, screened.

The conversion of the polymer to the cation exchanger takes place by sulfonation, using sulfuric acid. It is preferable to use sulfuric acid at a concentration of 90 to 100%, particularly preferably 96 to 99%. According to the invention, the sulfonation takes place without addition of swelling agents (e.g., chlorobenzene or dichloroethane). The temperature during the sulfonation is significant for the properties of the cation exchanger produced. It is generally 100 to 150° C., preferably 110 to 130° C. The reaction mixture is stirred during the sulfonation. Use may be made here of various types of stirrer, such as blade, anchor, gate, or turbine stirrers.

In one particular embodiment of the present invention, the sulfonation takes place by what is known as the “semibatch process”. In this method, the polymer is metered into temperature-controlled sulfuric acid (for example; into sulfuric acid at 100° C.). It is particularly advantageous here for the metering to be carried out in portions.

After the sulfonation, the reaction mixture made from sulfonation product and residual acid is cooled to room temperature and diluted, first with sulfuric acids of decreasing concentrations, and then with water.

The cation exchangers obtained according to the invention have been uniformly and thoroughly sulfonated. They show no pattern under a polarizing microscope.

For many applications it is useful to convert the cation exchanger from the acidic form into the sodium form. This changeover takes place using sodium hydroxide solution whose concentration is 10 to 60%, preferably 40 to 50%. The temperature during the changeover may be 0 to 120° C. During this step of the process, the heat of reaction generated can be used to adjust the temperature.

The process of the invention may be operated in a process-controlled system as a continuous process, or as a batch process. In the case of the continuous process, the sulfonation step follows the polymerization step directly, whereas in the batch process the intermediate polymer produced is first placed into intermediate storage after filtration, decanting, washing and drying, and then at a subsequent juncture is subjected to the sulfonation step.

The cation exchangers obtained by the process of the invention have particularly high mechanical, osmotic and chemical stability, and purity. Even after prolonged usage and multiple regeneration, they exhibit no defects on the ion-exchanger beads and no leaching of the exchanger.

The particular osmotic and chemical stability and purity of the gel-type cation exchangers of the invention means that they can be used for treating drinking water, for purifying or treating water in the chemical, electrical, or electronics industry, for producing printed circuit boards or in the chip industry, particularly for producing ultrahigh-purity water, for the chromatographic separation of sugars, i.e., in the food or drinks industry, or for the purification, decationization, softening, decolorization, or desalination of aqueous solutions of organic products, such as sugar, starch hydrolysates, gelatin, fruit juices, other fruit drinks, or whey.

The present invention therefore also provides the use of the gel-type cation exchanger prepared according to the invention

for the removal of cations, color particles, or organic components from aqueous or organic solutions or condensates (e.g., process condensates or turbine condensates),

for softening in the course of neutral exchange of aqueous or organic solutions or condensates (e.g., process condensates or turbine condensates),

for the purification, decationization, softening, decolorization, or desalination of aqueous solutions of organic products,

for the purification or treatment of water from the chemical industry, from the electronics industry, or from power plants,

for the complete desalination of aqueous solutions and/or condensates, when used in combination with gel-type and/or macroporous anion exchangers.

The present invention therefore also provides processes

for softening in the course of neutral exchange of aqueous or organic solutions or condensates (e.g., process condensates or turbine condensates) using gel-type cation exchangers prepared according to the invention,

for the complete desalination of aqueous solutions and/or condensates (e.g., process condensates or turbine condensates) using gel-type cation exchangers prepared according to the invention in combination with heterodisperse or monodisperse, gel-type and/or macroporous anion exchangers,

for the purification or treatment of water from the chemical industry, from the electronics industry, or from power plants using gel-type cation exchangers prepared according to the invention,

for the removal of cations, color particles or organic components from aqueous or organic solutions or condensates (e.g., process condensates or turbine condensates) using gel-type cation exchangers prepared according to the invention,

and for the decolorization, desalination, purification, decationization, or softening of aqueous solutions of organic products, such as sugar, starch hydrolysates, gelatin, glycerol, fruit juices, other fruit drinks, or whey, in the sugar industry, in the starch industry, in the pharmaceutical industry, or in dairies.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

Characterization of Osmotic Stability of Cation Exchangers by Immersion in Alkali

2 ml of sulfonated polymer in the H form are introduced, with stirring, into 50 ml of 45% by weight of sodium hydroxide solution at room temperature. The suspension is allowed to stand overnight. A representative specimen is then removed. 100 beads are inspected under the microscope. The number of perfect, undamaged beads among these is determined.

Characterization of Osmotic Stability of Cation Exchangers by a Swelling Stability Test

25 ml of cation exchanger are installed in a column. After 3 minutes of washing with deionized water, the resin is treated 40 times in succession with 6% strength by weight hydrochloric acid and 4% strength by weight sodium hydroxide solution, on each occasion for 10 min. After each acid treatment and alkali treatment, respectively, the exchanger is rinsed with deionized water for 5 min. The cation exchanger is then flushed out from the filter tube and thoroughly mixed after removal of the water by suction. A specimen of this material is taken and the number of perfect beads is counted under the microscope. The proportion of perfect, undamaged beads is determined.

### Example 1 (Comparative Example)

a) Preparation of a Polymer

As in Example 1 of EP-A 994,124, an acrylonitrile-containing styrene-divinylbenzene polymer was prepared from a microencapsulated styrene-divinylbenzene mixture with a divinylbenzene content of 10.5% by weight, with addition of 4% by weight of acrylonitrile into the aqueous phase. The ratio of monomer mixture to aqueous phase (liquor ratio) was 1:2.0.

b) Preparation of a Cation Exchanger

1800 ml of 97.32% strength by weight sulfuric acid were charged to a 2 liter four-necked flask and heated to 100° C. A total of 400 g of dry polymer from 1a) were introduced, with stirring, over a period of 4 hours in 10 portions. This was followed by 6 further hours of stirring at 115° C. After cooling, the suspension was transferred into a glass column and treated first with sulfuric acids of decreasing concentrations, beginning with 90% by weight, and finally with pure water. This gave 1790 ml of cation exchanger in the H form. Under the polarizing microscope the cation exchanger had a radiant structure, indicating inhomogeneity and incomplete sulfonation.

| | |
|---|---|
| Stability test/alkali immersion | 18/100 |
| Proportion of perfect beads | |
| Swelling stability | 23/100 |
| Proportion of perfect beads | |

### Example 2

a) Preparation of Polymer A (According to the Invention)

985.6 g of an aqueous mixture comprising 492.8 g of monodisperse microencapsulated monomer droplets with a median particle size of 430 μm and with a Ø(90)/Ø(10) value of 1.11, composed of 91.04% by weight of styrene, 8.46% by weight of divinylbenzene, and 0.50% by weight of dibenzoyl peroxide, were mixed with an aqueous solution made from 1.48 g of gelatin, 2.22 g of sodium hydrogen phosphate dodecahydrate and 110 mg of resorcinol in 40 ml of deionized water, and 31.5 g of acrylonitrile, in a 4 liter glass reactor. The mixture was polymerized, with stirring (stirrer speed 220 rpm) for 6 h at 70° C. and then 2 h at 95° C., and washed using a 32 μm screen and dried. This gave 512 g of a bead polymer with a smooth surface. The polymer was visually transparent.

b) Preparation of Polymer B (According to the Invention)

985.6 g of an aqueous mixture comprising 492.8 g of monodisperse microencapsulated monomer droplets with a median particle size of 430 μm and with a Ø(90)/Ø(10) value of 1.08, composed of 91.54% by weight of styrene, 7.96% by weight of divinylbenzene, and 0.55% by weight of tert-butylperoxy 2-ethylhexanoate, were mixed with an aqueous solution made from 0.88 g of gelatin, 1.46 g of sodium hydrogen phosphate dodecahydrate and 70 mg of resorcinol in 110 ml of deionized water, and 33.1 g of acrylonitrile, in a 4 liter glass reactor. The mixture was polymerized, with stirring (stirrer speed 220 rpm) for 6 h at 63° C. and then 2 h at 92° C., and washed by way of a 32 μm screen and dried. This gave 498 g of a bead polymer with a smooth surface. The polymer was visually transparent.

c) Preparation of Polymers C to D (According to the Invention)

In each case, 985.6 g of an aqueous mixture comprising 492.8 g of monodisperse microencapsulated monomer droplets with a median particle size of 430 μm and with a Ø(90)/Ø(10) value of 1.11, composed of 91.04% by weight of styrene, 8.46% by weight of divinylbenzene and 0.50% by weight of dibenzoyl peroxide, were mixed with an aqueous solution made from 1.48 g of gelatin, 2.22 g of sodium hydrogen phosphate dodecahydrate and 110 mg of resorcinol in 387.5 ml of deionized water, and acrylonitrile, in a 4 liter glass reactor. The amounts of acrylonitrile used are given in Table 1. The mixtures were polymerized, with stirring (stirrer speed 220 rpm) for 6 h at 70° C. and then 2 h at 95° C., and washed using a 32 μm screen and dried. This gave 507 g and 504 g, respectively, of a bead polymer with a smooth surface. The polymer was visually transparent.

d) Preparation of Polymer E (Not According to the Invention)

516.8 g of an aqueous mixture comprising 258.4 g of monodisperse microencapsulated monomer droplets with a median particle size of 430 μm and with a Ø(90)/Ø(10) value of 1.09, composed of 91.0% by weight of styrene, 8.45% by weight of divinylbenzene and 0.55% by weight of tert-butyl peroxy 2-ethylhexanoate, were mixed with an aqueous solution made from 1.48 g of gelatin, 2.22 g of sodium hydrogen phosphate dodecahydrate and 110 mg of resorcinol in 969.2 ml of deionized water, and 22.1 g of acrylonitrile, in a 4 liter glass reactor. The mixture was polymerized, with stirring (stirrer speed 220 rpm) for 6 h at 70° C. and then 2 h at 95° C., and washed using a 32 μm screen and dried. This gave 249 g of a bead polymer with a smooth surface. The polymer was visually transparent.

e) Preparation of Cation Exchangers A to E

1800 ml of 97.32% strength by weight sulfuric acid were charged to a 2 liter four-necked flask and heated to 100° C. A total of 400 g of dry polymer from 2a) to 2d) were introduced, with stirring, over a period of 4 hours in 10 portions. This was followed by 6 further hours of stirring at 115° C. and 120° C., respectively. After cooling, the suspension was transferred into a glass column and treated first with sulfuric acids of decreasing concentrations, beginning with 90% by weight, and finally with pure water.

Results of Examples 2a) to 2e) in Table Form (Table 1)

| | | | | | E |
|---|---|---|---|---|---|
| | A | B | C | D | not |
| Cation exchanger | in- | in- | in- | in- | in- |
| No. | ventive | ventive | ventive | ventive | ventive |
| Acrylonitrile [g] | 31.5 | 33.1 | 28.7 | 31.5 | 22.1 |
| Acrylonitrile: | 0.76 | 0.84 | 0.69 | 0.76 | 1.01 |
| divinylbenzene | | | | | |
| Acrylonitrile in polymer | 5.7* | 6.3* | 5.5* | 6.0* | 6.4* |
| [%] | | | | | |
| Liquor ratio | 1:1.09 | 1:1.31 | 1:1.79 | 1:1.79 | 1:4.92 |
| Sulfonation | 115 | 120 | 115 | 115 | 120 |
| temperature [° C.] | | | | | |
| Cation exchanger (H | | 1820 | 1760 | 1740 | 1760 |
| form) [ml] | | | | | |
| Stability test/alkali | | 60/100 | 85/100 | 99/100 | 5/100 |
| immersion | | | | | |
| Proportion of perfect | | | | | |
| beads | | | | | |
| Swelling stability | | 64/100 | | 98/100 | 22/100 |
| Proportion of perfect | | | | | |
| beads | | | | | |

*determined by elemental analysis for nitrogen

### Example 3 (According to the Invention)

a) Preparation of Polymer F

By analogy with Example 2c), other polymers were prepared from monodisperse microencapsulated monomer droplets with a median particle size of 430 μm and a Ø(90)/Ø(10) value of 1.11, composed of 91.04% by weight of styrene, 8.46% by weight of divinylbenzene and 0.50% by weight of dibenzoyl peroxide, and 31.5 g of acrylonitrile. The ratio acrylonitrile/divinylbenzene is 0.71 and the liquor ratio monomer phase/aqueous phase is 1:1.79. Elemental analysis was used to determine the extent of incorporation of acrylonitrile into the organic phase, which was 6.0% by weight.

b) Preparation of Cation Exchangers F to K

1800 ml of 97.32% strength by weight sulfuric acid were charged to a 2 liter four-necked flask and heated to 100° C. A total of 400 g of dry polymer from 3a) were introduced, with stirring, over a period of 4 hours in 10 portions. This was followed by 6 further hours of stirring at the desired sulfonation temperature. After cooling, the suspension was transferred into a glass column and treated first with sulfuric acids of decreasing concentrations, beginning with 90% by weight, and finally with pure water.

Results of Examples 3a) to 3b) in Table Form (Table 2)

| Cation exchanger No. | F | G | H | I | K |
|---|---|---|---|---|---|
| Sulfonation temperature | 100 | 105 | 110 | 115 | 120 |
| [° C.] | | | | | |
| Cation exchanger (H | 1555 | 1805 | 1805 | 1805 | 1805 |
| form) [ml] | | | | | |
| Stability test/alkali | 35/100 | 57/100 | 65/100 | 68/100 | 72/100 |
| immersion | | | | | |
| Proportion of perfect | | | | | |
| beads | | | | | |
| Swelling stability | | 60/100 | 60/100 | 79/100 | 93/100 |
| Proportion of perfect | | | | | |
| beads | | | | | |

### Example 4 (According to the Invention)

a) Preparation of Polymer G

A monomer mixture composed of 793.3 g of styrene, 94.2 g of 80.6% strength by weight divinylbenzene, and 5.7 g of dibenzoyl peroxide was mixed with an aqueous solution made from 7.05 g of hydroxyethylcellulose in 1763 ml of deionized water and 61.7 g of acrylonitrile, in a 4 liter glass reactor (acrylonitrile:divinylbenzene ratio of 0.81). The ratio monomer mixture/aqueous phase (liquor ratio) was 1:1.86. The mixture was polymerized, with stirring (stirrer speed 350 rpm) for 10 h at 63° C. and then for 2 h at 95° C., and washed by way of a 32 μm screen and dried. This gave 879 g of a bead polymer with a smooth surface. The polymer was visually transparent.

b) Preparation of Cation Exchanger L

1800 ml of 97.32% strength by weight sulfuric acid were charged to a 2 liter four-necked flask and heated to 100° C. A total of 400 g of dry polymer from 4a) were introduced, with stirring, over a period of 4 hours in 10 portions. This was followed by 6 further hours of stirring at 115° C. After cooling, the suspension was transferred into a glass column and treated first with sulfuric acids of decreasing concentrations, beginning with 90% by weight, and finally with pure water. This gave 1780 ml of cation exchanger in the H form.

| | |
|---|---|
| Stability test/alkali | 65/100 |
| immersion | |
| Proportion of perfect beads | |
| Swelling stability | 74/100 |
| Proportion of perfect beads | |

What is claimed is:

1. A process for preparing stable gel-type cation exchangers comprising
(1) polymerizing a mixture comprising from 90 to 95% by weight of styrene and 5 to 10% by weight of divinylbenzene by the suspension polymerization procedure at a liquor ratio (o/w) of from 1:1 to 1:2.5 in the presence of 5 to 8% by weight of acrylonitrile, based on the entirety of styrene and divinylbenzene, in the aqueous phase, and
(2) sulfonating the resultant copolymer using sulfuric acid in the absence of any swelling agent.

2. A process according to claim 1 wherein the ratio by weight of acrylonitrile to divinylbenzene is 0.6 to 1.

3. A process according to claim 1 wherein the liquor ratio (o/w) is from 1:1.2 to 1:2.2.

4. A process according to claim 1 wherein the mixture comprising styrene and divinylbenzene has been microencapsulated.

5. A process according to claim 1 wherein the sulfonation is carried out at from 110 to 130° C.

6. A process according to claim 5 wherein the sulfonation is carried out by the semibatch process.

7. A process according to claim 1 carried out continuously or batchwise.

8. A stable gel-type cation exchanger obtained by
(1) polymerizing, in the aqueous phase, a mixture comprising from 90 to 95% by weight of styrene and 5 to 10% by weight of divinylbenzene, by the suspension polymerization procedure, at a liquor ratio (o/w) of from 1:1 to 1:2.5 in the presence of from 5 to 8% by weight of acrylonitrile, based on the entirety of styrene and divinylbenzene, and
(2) sulfonating the resultant copolymer using sulfuric acid in the absence of any swelling agent.

9. A method comprising treating drinking water with a stable gel-type cation exchanger according to claim 8.

10. A method comprising purifying or treating water in the chemical, electrical, or electronics industry with a stable gel-type cation exchanger according to claim 8.

11. A method comprising producing ultrahigh-purity water for producing printed circuit boards or electronic chips with a stable gel-type cation exchanger according to claim 8.

12. A method comprising chromatographically separating sugars with a stable gel-type cation exchanger according to claim 8.

13. A method comprising decolorizing, desalinating, purifying, decarbonizing, or softening aqueous solutions of organic products in the sugar industry, in the starch industry, in the pharmaceutical industry or in dairies with a stable gel-type cation exchanger according to claim 8.
